(19) United States
(12) Patent Application Publication
(10) Pub. No.: US 2006/0263516 A1
(43) Pub. Date: Nov. 23, 2006

(54) Hydrophobic coating

(75) Inventors: Ashley Ward Jones, Sydney (AU); Hua Zhang, Sydney (AU); Robert Norman Lamb, Sydney (AU)

Correspondence Address: FITCH EVEN TABIN AND FLANNERY, 120 SOUTH LA SALLE STREET, SUITE 1600, CHICAGO, IL, 60603-3406, US

(73) Assignee: NewSouth Innovations Pty Limited Rupert Myers Building, Sydney, NSW (AU)

(21) Appl. No.: 10/552,533

(22) PCT Filed: Apr. 8, 2004
(86) PCT No.: PCT/AU04/00461

§ 371 Date: Jun. 29, 2006

(30) Foreign Application Priority Data
Apr. 11, 2003 (AU) 2003901734

(51) Int. Cl. B05D 1/12; B05D 3/02

(52) U.S. Cl. 427/180; 427/372.2

(57) ABSTRACT

A method of forming a hydrophobic coating on the surface of a substrate, the method comprises the steps of (a) forming an emulsion comprising particulate material, a decomposable surfactant, water and an organic solvent; (b) applying the emulsion to the surface to form a coating on the surface; (c) exposing the coating to conditions such that all or substantially all of the water and the organic solvent are removed from the coating, and the particles of the particulate material become bound together and to the surface; and (d) exposing the coating to conditions such that the decomposable surfactant decomposes.

### TECHNICAL FIELD

The invention relates to the technology of coatings. In particular, the invention relates to a method of forming hydrophobic coatings on the surface of a substrate, and hydrophobic coatings produced by the method.

### BACKGROUND ART

Wettability is an indicator of the affinity of a solid surface for a liquid. The wettability of a surface is dependent on both the physical and chemical heterogeneity of the surface.

The contact angle θ made by a droplet of liquid on the surface of a solid substrate is used as a quantitative measure of the wettability of the surface. If the liquid spreads completely across the surface and forms a film, the contact angle θ is 0°. If there is any degree of beading of the liquid on the surface, the surface is considered to be non-wetting.

A surface is usually considered to be hydrophobic if the contact angle of a droplet of water is greater than 90°. Coatings on which water has a contact angle greater than 90° are referred to as hydrophobic coatings. Surfaces with water contact angles greater than 150° are commonly referred to as superhydrophobic. Similarly, coatings on which water has a contact angle greater than 150° are commonly referred to as superhydrophobic coatings.

Hydrophobic surfaces have little or no tendency to absorb water and water forms a discrete droplet on the surface. An example of a hydrophobic surface is a polytetrafluroethylene (Teflon™) surface. Water contact angles on a polytetrafluoroethylene surface can reach about 115°. This is about the upper limit of hydrophobicity on smooth surfaces. The contact angle of a droplet of water on a surface can be increased, however, by causing the surface to become physically roughened.

If the surface is rough or heterogeneous there are usually two contact angles that can be measured. Tilting the substrate until the droplet is about to roll off illustrates this phenomena. The contact angle of the leading edge of the droplet represents the largest measurable contact angle (called the advancing angle or θ_{adv}). The contact angle of the receding edge or tail of the droplet represents the minimum measurable contact angle (called the receding angle or θ_{rec}). The difference between the advancing and receding contact angles is known as the contact angle hysteresis and defines the degree of dynamic wettability.

The contact angle hysteresis of water indicates the stability of a droplet of water on the surface; the lower the contact angle hysteresis the less stable the droplet is and therefore the easier the water droplet slides off the surface.

Hydrophobic coatings, and in particular superhydrophobic coatings, have many uses. Hydrophobic coatings are used to render surfaces water proof or water resistant. Superhydrophobic coatings have a “self-cleaning” property as dirt, bacteria, spores or other substances that come into contact with the surface cannot readily adhere to the coating and are readily washed off by water. Such coating are used to render surfaces resistant to attachment by water soluble electrolytes, such as acids and alkalies, dirt and micro-organisms. Such coatings are also used to render surfaces resistant to icing and fouling.

Methods of forming superhydrophobic coatings, and applying superhydrophobic coatings to surfaces, have been described in the prior art. For example, WO 98/42452 describes a method of preparing superhydrophobic coatings.

Prior art methods of forming superhydrophobic coatings on the surface of a substrate typically use a significant amount of organic solvents. For example, WO 98/42452 describes a method of forming a superhydrophobic coating on a surface involving applying particles to the surface in the form of a slurry of the particles in an organic solvent such as hexane. The use of such solvents is undesirable as such solvents have adverse environmental effects, and are often toxic and flammable and therefore need to be handled with care. It would therefore be desirable to develop alternative methods of forming superhydrophobic coatings.

Superhydrophobic coatings are generally opaque. This is because the hydrophobicity of such coatings is due to both the chemical hydrophobicity of the surface of the coating and the rough surface structure of the coating. Rough surfaces tend to scatter light which causes the surface of the coating to appear opaque. It would be advantageous to develop a method of forming hydrophobic coatings on the surface of a substrate that can be used to form transparent hydrophobic and transparent superhydrophobic coatings.

Such coatings could then be applied to surfaces where it is desirable for the coating to be transparent, for example, the surfaces of glass windows.

### SUMMARY OF THE INVENTION

The present inventors have now developed a new method of forming hydrophobic coatings on the surface of a substrate.

In a first aspect, the present invention provides a method of forming a hydrophobic coating on the surface of a substrate, the method comprising the steps of:
(a) forming an emulsion comprising particulate material, a decomposable surfactant, water and an organic solvent;
(b) applying the emulsion to the surface to form a coating on the surface;
(c) exposing the coating to conditions such that all or substantially all of the water and the organic solvent are removed from the coating, and the particles of the particulate material become bound together and to the surface; and
(d) exposing the coating to conditions such that the decomposable surfactant decomposes.

Typically, the contact angle of water on the coating formed by the method of the present invention is at least 130°.

Preferably, the coating formed by the method of the present invention is such that water has a contact angle on the coating of at least 150°, more preferably at least 160°, and most preferably about 165° or more.

Without wishing to be bound by theory, it is believed that the decomposition of the decomposable surfactant contributes to the hydrophobicity of the coatings formed by the method of the present invention through the decomposition of the decomposable surfactant producing volatile components, which are emitted from the coating giving the coatings formed by the method of the present invention a porous surface structure that contributes to the hydrophobicity of the coating.

The method of the invention can be used to apply thin hydrophobic coatings to a surface. For example, the method can be used to prepare hydrophobic coatings having a thickness of less than 100 nm. The inventors have surprisingly found that in some embodiments of the present invention, the coatings formed by the method of the present invention, particularly thin coatings having a thickness of less than 100 nm, are transparent to visible light. Without wishing to be bound by theory, it is believed that the decomposition of the decomposable surfactant results in the coatings formed by the method of the present invention having a porous surface structure which contributes to the hydrophobicity of the coating, and which also, in some coatings formed by the method of the invention, gives the coating a transparent appearance.

In a second aspect, the present invention provides a coating formed by the method according to the first aspect of the present invention.

In a third aspect, the present invention provides an object having a surface at least a portion of which is coated with a hydrophobic coating formed by the method according to the first aspect of the present invention.

In a fourth aspect, the present invention provides a transparent hydrophobic coating on which water has a contact angle of at least 130°.

### DETAILED DESCRIPTION OF THE INVENTION

In some embodiments, the particles of the particulate material have functional groups that are capable of reacting with other particles of the particulate material and the surface to bind the particles together and to the surface. However, more typically, the emulsion further comprises a linking agent capable of reacting with the particles and the surface to bind the particles together and to the surface. In such a case, in step (c) of the method of the invention, the linking agent reacts with the particles and the surface to bind the particles together and to the surface.

In some embodiments, the linking agent is a polymer or mixture of polymers capable of reacting with two or more of the particles to link the particles by a polymer strand, and capable of reacting with the surface and one or more of the particles to link the surface and the one or more particles by a polymer strand. Such a linking agent links the two or more particles by a polymer strand covalently bound to the particles, and links the surface and the one or more particles by a polymer strand covalently bound to the surface and the one or more particles. When the particles of the particulate material have hydroxyl groups on the surface of the particles, examples of the polymers that may be used as the linking agent include siloxane polymers such as hydroxy terminated polydimethylsiloxane (PDMS), hydroxy terminated polydiphenylsiloxane, hydroxy terminated polyphenyhnethylsiloxane, methylhydrosiloxane (and copolymers with dimethylsiloxane), vinylmethyoxysiloxane homopolymer, polytrifluoropropylmethylsiloxane(silanol terminated), vinylmethylsiloxane, dimethylsiloxane copolymer (silanol terminated), vinylmethylsiloxanes, epoxysiloxanes and methacrylatesiloxanes. Other polymers which may be used include modified polystyrene, polyethylenes or fluorinated polymers. Suitable polymers also include triethoxysilyl modified poly-1,2-butadiene and polyethylene-co-trialkoxyvinylsilane.

In other embodiments, the linking agent is a monomer or mixture of monomers capable of reacting with the particles and the surface, and capable of forming a polymer strand linking two or more particles of the particulate material and capable of forming a polymer strand linking the surface and one or more particles of the particulate material. Such a linking agent links the two or more particles by a polymer strand covalently bound to the particles, and links the surface and the one or more particles by a polymer strand covalently bound to the surface and the one or more particles. Such a linking agent may, for example, be a difunctional or trifunctional alkylsilane. The linking agent may for example be a compound of the formula SiR¹R²(R³)₂ where R¹ is an alkyl group, R² is an alkyl, hydrogen, methoxy or ethoxy group, and each R³ is independently selected and is a methoxy, ethoxy, hydroxyl or vinyl alkoxy group. Suitable linking agents include methyltrimethoxysilane, vinyltrimethoxysilane, methyltris(methylethylketoximino)silane, methyltriacetoxysilane, ethyltriacetoxysilane or vinyltriacetoxysilane.

In those embodiments of the invention in which, in step (c), the particles become linked together and to the surface by polymer strands, the method may include a further step during or after step (c) or (d) of exposing the coating to conditions such that the polymer strands liking the particles together and to the surface are cross-linked as described in the applicant's co-pending International application filed on the same date titled “Durable Superhydrophobic Coating”.

The particulate material may consist of particles having substantially equal diameters, or alternatively having a spectrum of diameters. Preferably, at least some of the particles have diameters within the range of from 1 nm to 500 μm. More preferably, all or substantially all of the particles have diameters in the range of from 1 nm to 500 μm, more preferably in the range of from 1 nm to 100 μm, more preferably in the range of from 1 nm to 50 μm, more preferably in the range of from 1 nm to 1 μm, still more preferably in the range of from 1 nm to 100 nm, and even more preferably in the range of from 5 nm to 50 nm. In some preferred embodiments, the particulate material consists of particles having an average particle size (diameter) in the range of from 1 nm to 500 μm, more preferably in the range of from 1 nm to 50 μm. In some embodiments, the average particle size is in the range from 5 nm to 50 nm. In yet a further embodiment, the average particle size is in the range from 5 nm to 20 nm. In yet a further embodiment, the average particle size is about 15 nm.

In a preferred embodiment, the present invention provides a method of forming a hydrophobic coating on the surface of a substrate, the method comprising the steps of:
(a) forming an emulsion comprising particulate material, wherein the particles of the particulate material have an average particle size in the range of 1 nm to 50 μm, a decomposable surfactant, water, an organic solvent, and a linking agent capable of reacting with the particles of the particulate material and the surface to bind the particles together and to the surface;
(b) applying the emulsion to the surface to form a coating on the surface;
(c) exposing the coating to conditions such that all or substantially all of the water and the organic solvent are removed from the coating, and the linking agent reacts with the particles of the particulate material and the surface to bind the particles together and to the surface; and
(d) exposing the coating to conditions such that the decomposable surfactant decomposes.

In a preferred embodiment, the particulate material comprises silica particles. Silica is relatively cheap and is readily available as a commercial powdered product known as Aerosil™ flamed silica. Although silica and silica-based particulate materials are preferred, other particulate material which has an appropriate particle size could be used. Examples of other such particulate materials include metal particles, glass particles and particles of metal oxides such as titanium oxide, aluminium oxide, zirconium oxide and zinc oxide. A mixture of two or more types of particulate materials can be used, eg a mixture of silica particles and particles of a metal oxide.

In some embodiments of the present invention, the particles of the particulate material are modified by contact with a surface modifier capable of reacting with the particles to enhance the chemical hydrophobicity of the particles, and thus the hydrophobicity of the coating formed by the method of the present invention. Typically, the chemical hydrophobicity is enhanced by the surface modifier reacting with a hydrophilic group (e.g. a hydroxyl group) on the surface of the particles to remove the hydrophilic group or to convert the hydrophilic group to a hydrophobic group. The surface modifier may also react with the surface of the particles to form functional groups on the surface of the particles that facilitate the reaction of the linking agent with the particles in step (c) of the method of the present invention.

The particulate material may be contacted with the surface modifier prior to the formation of the emulsion at step (a) of the method. Alternatively, the surface modifier may be included in the emulsion. Accordingly, in some embodiments of the present invention, the emulsion further comprises a surface modifier capable of reacting with at least some of the particles of the particulate material to enhance the chemical hydrophobicity of the particles.

The surface modifier may for example be a compound containing one or more condensation cure groups and one or more hydrophobic groups. The one or more condensation cure groups may for example be acetoxy, enoxy, oxime, alkoxy or amine. Such surface modifiers include compounds of the formula SiR¹(OR²)₃, where R¹ is a hydrophobic group such as alkyl (e.g. methyl or ethyl), vinyl, epoxyalkyl, methacrylate or perfluoroalkyl (e.g. trifluoropropyl), and each R² is independently selected and is methyl, ethyl or acetyl.

The same compound may act as both a linking agent and a surface modifier, or alternatively different compounds may be used as the linking agent and the surface modifier.

The decomposable surfactant may be any surfactant capable of forming an emulsion comprising the particulate material, the organic solvent and water, and which decomposes in step (d) of the method of invention. Preferably the decomposable surfactant decomposes leaving no residue or only hydrophobic residues in the coating. The decomposable surfactant acts as an emulsifier so that the particulate material, water and organic solvent form an emulsion.

Typically, the decomposable surfactant is polyether modified polydimethylsiloxane or polyethoxylate modified polydimethylsiloxane. These surfactants decompose at about 400° C. leaving behind a chemically hydrophobic siloxane residue. That is, the polyether or the polyethoxylate portion of the surfactant decomposes leaving only the hydrophobic siloxane portion. Other decomposable surfactants which may be used include pyridinium, or 1-[2-(octadecyloxy)-2-oxoethyl]-chloride(9Cl) [CAS 4987-84-2].

The organic solvent is typically a non-polar organic solvent such as toluene, ethyl acetate or xylene. Other suitable organic solvents include, for example, hexane or diethylether. When the emulsion includes a linking agent, the linking agent is typically dissolved in the organic solvent.

The emulsion comprising the particulate material, the decomposable surfactant, water and the organic solvent, and optionally, a linking agent and/or a surface modifier, may be formed by thoroughly mixing those components, for example in a ultrasonic bath.

The emulsion may be applied to the surface of the substrate by any known technique of applying an emulsion to a surface. Such techniques include dip coating, spin coating and spray coating. Alternatively, brush or roll application to the surface could be used for some emulsions. For preparing transparent coatings, spin coating is preferred as spin coating can be used to prepare uniform thin coatings on a surface. The emulsion may be applied to the surface to form thick coatings or thin films on the surface.

Step (c) of the method of the invention involves exposing the coating to conditions effective to remove all or substantially all of the water and the organic solvent from the coating and for the particles of the particulate material to become bound together and to the surface. The conditions will vary depending on the particulate material, the organic solvent and the linking agent, if any, used.

In some embodiments of the invention, the particles of the particulate material become bound together and to the surface at ambient temperatures (for example at about 15 to 25° C). In such a case, step (c) may comprise exposing the coating to ambient temperatures for a time sufficient for all or substantially all of the water and the organic solvent to evaporate from the coating, and for the particles of the particulate material to become bound together and to the surface.

When a monomer such as methyltriacetoxysilane is used as the linking agent, step (c) typically comprises heating the coating to a temperature and for a time effective to evaporate all or substantially all of the water and the organic solvent from the coating and to cause the linking agent to bind the particles of the particulate material together and to the surface.

Step (c) may involve exposing the coating to one set of conditions to remove all or substantially all of the water and the organic solvent from the coating, and exposing the coating to a different set of conditions to cause the particles of the particulate material to become bound together and to the surface.

Step (d) of the method of the invention involves exposing the coating to conditions effective to decompose the decomposable surfactant.

When the decomposable surfactant is a surfactant such as polyether modified polydimethylsiloxane or polyethoxylate modified polydimethylsiloxane which decomposes at above ambient temperatures, step (d) typically comprises heating the coating to a temperature effective to cause decomposition of the decomposable surfactant.

In some embodiments of the present invention, the emulsion further comprises a catalyst for catalysing the decomposition of the decomposable surfactant. An example of such a catalyst is photocatalytic titanium dioxide. Photocatalytic titanium dioxide is typically included in the emulsion in the form of small particles and may therefore form part of the particulate material. In such a case, the titanium dioxide catalyst typically comprises about 2-10% by weight of the particulate material. If such a catalyst is used, step (d) comprises exposing the coating to conditions (e.g. light) effective to cause the catalyst to catalyse the decomposition of the decomposable surfactant.

In some embodiments of the invention, steps (c) and (d) are carried out simultaneously. In other embodiments of the invention, step (c) is carried out prior to step (d). Preferably, the particulate material, the decomposable surfactant, the organic solvent, the linking agent, if any, and the catalyst for catalysing the decomposition of the surfactant, if any, are selected such that steps (c) and (d) can be carried out simultaneously.

A particularly preferred particulate material is flame-hydrolysed silica powder, such as that commercially available as Aeorsil™ silica power from Degussa Limited, comprising particles having a primary size in the range of 5 nm to 10 nm. Flame-hydrolysed silica particles contain hydrophilic silanol (═Si—OH) functional groups on the surface of the particles. In preferred embodiments of the method of the invention, these functional groups are converted to hydrophobic siloxane groups (═Si—O—Si═), either by reaction with a surface modifier or by reaction with a linking agent.

In a preferred embodiment of the present invention, the particulate material comprises flame hydrolysed silica particles, the decomposable surfactant is polyether modified polydimethylsiloxane or polyethoxylate modified polydimethylsiloxane, and the emulsion includes methyltriacetoxysilane. In this embodiment of the present invention, the methyltriacetoxysilane acts both as a surface modifier to increase the chemical hydrophobicity of the silica particles and also acts as a linking agent. During the method of the invention, the methyltriacetoxysilane forms polymer strands linking the silica particles together and to the surface. In this embodiment of the invention, steps (c) and (d) can be carried out by heating the coating to about 450° C.

The method of the present invention has an advantage in that by using an emulsion comprising an organic solvent and water, the method involves the use of less volatile organic compounds than some prior art methods of forming superhydrophobic coatings that involve the use of a slurry of particulate material in an organic solvent. In addition, the emulsion is easier to handle than a slurry of particulate material in an organic solvent. In addition, the decomposition of the decomposable surfactant enhances the roughness of the surface of the coatings formed by the method of the present invention, contributing to the hydrophobicity of the coating. Further, in some embodiments, the method of the present invention can be used to form transparent hydrophobic coatings.

The present inventors have found that to prepare a transparent hydrophobic coating it is preferable to use particulate material wherein the particles of the particulate material have an average particle size in the range of from 1 nm to 50 μm, more preferably from 1 nm to 5 μm, and even more preferably from 5 nm to 50 nm.

The hydrophobicity of the coatings formed by the method of the present invention is typically due to a combination of both the chemical hydrophobicity of the surface of the coating and the physical surface structure of the surface of the coating. Accordingly, during the method of the present invention, the particles of the particulate material, if not initially chemically hydrophobic, preferably become chemically hydrophobic. The particles of the particulate material may become chemically hydrophobic as a result of hydrophilic groups on the particles reacting with other particles, reacting with a linking agent, or reacting with a surface modifier. Similarly, it is preferred that if a linking agent is used, the linking agent reacts with the particles, the surface modifier or other molecules of the linking agent to form chemically hydrophobic groups, such as hydrophobic polymer strands, linking the particles together and to the surface.

The method of the present invention can be used to form coatings on the surface of a wide variety of substrates including metals, alloys, glasses, ceramics, composites, fabrics, and other materials.

The hydrophobic or superhydrophobic coatings formed by the method of the present invention have many applications. For example, the hydrophobic or superhydrophobic coatings can be used to render surfaces of a substrate water resistant or water proof. Superhydrophobic coatings formed by the method of the present invention can also be used to render surfaces resistant to icing and fouling. Such coatings can also be used to render a surface resistant to attachment by water soluble electrolytes, such as acids and alkalines, or other material, such as dirt or microorganisms.

Transparent hydrophobic or superhydrophobic coatings produced by the method of the invention have many practical applications, such as coatings for eye glasses, optical lenses, cover glasses for solar cells, wind shields of automobiles, use on traffic signs or lights, windows, mirrors, tiles etc.

The invention will now be described by reference to the following non-limiting examples. It will be appreciated by those in the art that numerous variations and/or modifications may be made to the invention as shown in the examples without departing from the spirit or scope of the invention as broadly described. The examples are, therefore, to be considered in all respects as illustrative and not restrictive.

### EXAMPLE 1

A superhydrophobic coating was prepared using the following procedure:
The following components were mixed together:
   0.05 g of polyethoxylate modified PDMS (hydroxy terminated)
   0.017 g of methyltriacetoxysilane
   1.045 g of fumed silica powder (having a primary particle size of 5 to 50 nm)
   3.33 ml of hexane
   0.85 ml of water
The mixture was mixed vigorously and vibrated in an ultrasonic bath for 30 minutes to disperse the particles and form a uniform emulsion. Vibration frequencies of about 40 kHz were used.
The emulsion was removed from the ultrasonic bath.
Drops of the emulsion were deposited onto the surface of a glass substrate using spin coating. Dip coating or spray coating could alternatively have been used to deposit the emulsion onto the surface.
The coated substrate was placed in oven at a temperature of about 450° C. for 30 minutes, forming a superhydrophobic coating on the surface of the substrate.

The contact angle and contact angle hysteresis of water and the transmittance of the coating were then measured. The contact angle and contact angle hysteresis were measured using an automated contact angle instrument goniometer (made by Ramé-hart. Inc). The transmittance was determined by visible spectral analysis.

| | |
|---|---|
| Contact angle: | 165° |
| Hysteresis: | 10° |
| Transmittance: | 96% |

### EXAMPLE 2

A hydrophobic coating was prepared using the following procedure:
The following components were mixed together:
   0.05 g of polyethoxylate modified PDMS (hydroxy terminated)
   0.01 7 g of methyltriacetoxysilane
   0.067 g of fumed silica powder (having a primary particle size of 5 to 50 nm)
   0.83 ml of hexane
   3.33 ml of water
The mixture was mixed vigorously and vibrated in an ultrasonic bath for 30 minutes to disperse the particles and form a uniform emulsion. Vibration frequencies of about 40 kHz were used.
The emulsion was removed from the ultrasonic bath.
Drops of the emulsion were deposited onto the surface of a glass substrate using spin coating. Dip coating or spray coating could alternatively have been used to deposit the emulsion onto the surface of the glass substrate.
The coated substrate was placed in oven at a temperature of about 450° C. for 30 minutes, forming a coating on the surface of the glass substrate.

The contact angle and contact angle hysteresis of water and the transmittance of the coating were then measured. The contact angle and contact angle hysteresis were measured using an automated contact angle instrument goniometer (made by Ramé-hart. Inc). The transmittance was determined by visible spectral analysis.

| | |
|---|---|
| Contact angle: | 142° |
| Hysteresis: | 50° |
| Transmittance: | 100% |

In the claims which follow and in the preceding description of the invention, except where the context requires otherwise due to express language or necessary implication, the word “comprising” and grammatical variations thereof is used in an inclusive sense, i.e. the features specified may be associated with further features in various embodiments of the invention.

1. A method of forming a hydrophobic coating on the surface of a substrate, the method comprising the steps of:
(a) forming an emulsion comprising particulate material, a decomposable surfactant, water and an organic solvent;
(b) applying the emulsion to the surface to form a coating on the surface;
(c) exposing the coating to conditions such that all or substantially all of the water and the organic solvent are removed from the coating, and the particles of the particulate material become bound together and to the surface; and
(d) exposing the coating to conditions such that the decomposable surfactant decomposes.

2. A method according to claim 1 wherein the contact angle of water on the coating formed by the method is at least 130°.

3. A method according to claim 1 wherein the emulsion further comprises a linking agent capable of reacting with the particles of the particulate material and the surface to bind the particles together and to the surface.

4. A method according to claim 3 wherein the linking agent is a polymer or mixture of polymers capable of reacting with two or more of the particles to link the particles by a polymer strand, and capable of reacting with the surface and one or more of the particles to link the surface and the one or more particles by a polymer strand.

5. A method according to claim 3 wherein the linking agent is a monomer or mixture of monomers capable of reacting with the particles and the surface, and capable of forming a polymer strand linking two or more of the particles and capable of forming a polymer strand linking the surface and one or more of the particles.

6. A method according to claim 5 wherein the linking agent is methyltrimethoxysilane, vinyltrimethoxysilane, methyltris(methylethylketoximino)silane, methyltriacetoxysilane, ethyltriacetoxysilane or vinyltriacetoxysilane.

7. A method according to claim 1 wherein the emulsion further comprises a surface modifier capable of reacting with at least some of the particles of the particulate material to increase the hydrophobicity of the particles.

8. A method according to claim 7 wherein the surface modifier is a compound containing one or more condensation cure groups and one or more hydrophobic groups.

9. A method according to claim 8 wherein the surface modifier is a compound of the formula SiR¹(OR²)₃, where R¹ is alkyl, vinyl, epoxyalkyl, methacrylate or perfluoroalkyl, and each R² is independently selected and is methyl, ethyl or acetyl.

10. A method according to claim 1 wherein the particulate material comprises silica particles.

11. A method according to claim 10 wherein the silica particles are flame hydrolysed silica particles.

12. A method according to claim 1 wherein the particulate material comprises metal particles, glass particles or particles of a metal oxide.

13. A method according to claim 12 wherein the metal oxide is titanium oxide, aluminium oxide, zirconium oxide or zinc oxide.

14. A method according claim 1 wherein the particles of the particulate material have an average particle size of from 1 nm to 500 μm.

15. A method according to claim 14 wherein the average particle size of the particles of the particulate material is in the range of from 1 nm to 50 μm.

16. A method according to claim 15 wherein the average particle size of the particles of the particulate material is in the range of from 1 nm to 50 nm.

17. A method according to claim 1 wherein the decomposable surfactant is polyether modified polydimethylsiloxane, polyethoxylate modified polydimethylsiloxane, pyridinium or 1-[2-(octadecyloxy)-2-oxoethyl]-chloride (9Cl).

18. A method according to claim 1 wherein the organic solvent is selected from toluene, ethylacetate, xylene, hexane or diethyl ether.

19. A method according to claim 1 wherein step (c) comprises heating the coating to a temperature and for a time effective to remove all or substantially all of the water and the organic solvent from the coating and for the particles of the particulate material to become bound together and to the surface.

20. A method according to claim 1 wherein step (d) comprises heating the coating to a temperature and for a time effective to decompose the decomposable surfactant.

21. A method according to claim 1 wherein steps (c) and (d) are carried out simultaneously.

22. A method according to claim 1 wherein step (c) is carried out prior to step (d).

23. A method according to claim 1 wherein the hydrophobic coating formed by the method has a thickness of less than 100nm.

24. A hydrophobic coating formed by the method according to claim 1.

25. An object having a surface at least a portion of which is coated with a hydrophobic coating formed by the method according to claim 1.

26. A transparent hydrophobic coating on which water has a contact angle of at least 130°.

27. A method of forming a hydrophobic coating on the surface of a substrate, the method comprising the steps of:
(a) forming an emulsion comprising particulate material, wherein the particles of the particulate material have an average particle size in the range of 1 nm to 50 μm, a decomposable surfactant, water, an organic solvent, and a linking agent capable of reacting with the particles of the particulate material and the surface to bind the particles together and to the surface;
(b) applying the emulsion to the surface to form a coating on the surface;
(c) exposing the coating to conditions such that all or substantially all of the water and the organic solvent are removed from the coating, and the linking agent reacts with the particles of the particulate material and the surface to bind the particles together and to the surface; and
(d) exposing the coating to conditions such that the decomposable surfactant decomposes.

28. A method according to claim 27 wherein the particulate material comprises silica particles.

29. A method according to claim 27 wherein the particulate material comprises metal particles, glass particles or particles of a metal oxide.

30. A method according to claim 27 wherein the particles of the particulate material have an average particle size of from 1 nm to 5 μm.

31. A method according to claim 27 wherein the linking agent is a bifunctional or trifunctional alkylsilane.

32. A method according to claim 31 wherein the linking agent is methyltrimethoxysilane, vinyltrimethoxysilane, methyltris(methylethylketoximino)silane, methyltriacetoxysilane, ethyltriacetoxysilane or vinyltriacetoxysilane.

33. A method according to claim 27 wherein step (c) comprises heating the coating to a temperature and for a time effective to remove all or substantially all of the water and organic solvent from the coating and to cause the linking agent to bind the particles together and to the surface.

34. A method according to claim 27 wherein step (d) comprises heating the coating to a temperature and for a time effective to cause decomposition of the decomposable surfactant.

35. A hydrophobic coating formed by the method of claim 27.
